(19) United States
(12) Patent Application Publication
(10) Pub. No.: US 2024/0369858 A1
(43) Pub. Date: Nov. 7, 2024

(54) EYEGLASS PROTECTION AND MOUNTING SYSTEMS

(71) Applicant: Melody Viscariello, Sun Lakes, AZ (US)

(72) Inventor: Melody Viscariello, Sun Lakes, AZ (US)

(21) Appl. No.: 18/141,925

(22) Filed: May 1, 2023

(51) Int. Cl. G02C 11/00

(52) U.S. Cl. CPC G02C 11/00

(57) ABSTRACT

An eyeglass protection and mounting system includes an elastic sleeve having two open ends and a cavity therebetween. The elastic sleeve may be passed over the lens upon the frame of the eyeglasses, and is long enough to extend over the ends of the lens on either side where the frame narrows. The sleeve also includes two retainers circumscribing the sleeve. These retainers may be elastic; i.e. a rubber ring. These retainers are able to shrink to a sufficient size that they are able to tension the sleeve around a temple of an eyeglass frame. These retainers allow the sleeve to be slid back onto the temple away from the lens when the user desires to wear the eyeglasses. The retainers retain the device to the temple even while the eyeglasses are being worn, and no separate stowage of the device is required.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of eyewear of existing art and more specifically relates to a protective eyeglass accessory.

### RELATED ART

Corrective eyewear has long been a medical solution for individuals suffering from vision problems. The most common eyewear solution are eyeglasses having two separate lenses positioned in front of each respective eye. Such a solution is simple and reliable; however, these lenses are expensive, and they are exposed and vulnerable to damage. Many users use bifurcated cases to stow their eyeglasses in when not worn in order to prevent accidental scratching of the lenses. However, such a solution is bulky and inconvenient, as when the eyeglasses are not stored, the case takes up space as a separate item. Accordingly, there is seen a need for a device which can protect the lenses of eyewear when the eyeglasses not in use, but which also saves bulk and does not take up space as a separate item when not used for storing the eyeglasses.

Various attempts have been made to solve problems found in eyeglass protection and storage art. Among these are found in: U.S. Patent and Publication Nos. 6,820,739, 2004/0149597, and 4,953,695. This prior art is representative of eyeglass covers. There is still perceived a need for a superior solution.

### SUMMARY OF THE INVENTION

The present invention advantageously fills the aforementioned deficiencies by providing a novel cover for eyeglass lenses. The present invention is superior to other systems in that it effectively provides a covering solution for eyeglass lenses which may be retained to the eyeglasses when not in use and, furthermore, provides a platform for attaching other stowed items.

The device includes an elastic sleeve having two open ends and a cavity therebetween. The sleeve is shaped such that it is barely large enough to stretch over one lens of an eyeglass. In this way, the sleeve may be passed over the lens upon the frame, and it is long enough to extend over the ends of the lens on either side where the frame narrows; here, the elastic shrinks down, and this retains the sleeve over the lens. However, due to the elastic nature of the sleeve, sufficient force applied by a user to pull off the sleeve from either end may be sufficient to remove it. The sleeve also includes two retainers, disposed one apiece proximal to each of the open ends, circumscribing the sleeve. These retainers may be elastic; i.e. a rubber ring. These retainers are able to shrink to a sufficient size that they are able to tension the sleeve around a temple of an eyeglass. Advantageously as regards the stowage problem, these retainers allow the sleeve to be slid back onto the temple away from the lens when the user desires to wear the eyeglasses. The retainers retain the device to the temple even while the eyeglasses are being worn, and no separate stowage of the device is required. In use, two of the present devices are to be required: one for each lens. In some embodiments, it is envisioned that a single cover could be used which is large enough to cover both lenses; however, two separate covers are deemed superior so that they may be more compactly stowed on each temple.

In addition, the device is envisioned as a platform for stowing additional objects upon the eyeglasses. This is achieved via a hanger affixed to the sleeve. In a preferred embodiment, this hanger takes the form of a small button sewn onto the sleeve. This button serves as a mounting point to hang an object upon the sleeve, especially when the sleeve is stowed upon the temple. For example, a face mask may be hung from the button. Additionally, a cord retainer may be provided to latch over the button.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an eyeglass protection and mounting system, constructed and operative according to the teachings of the present disclosure.

FIG. 1 is a perspective view of the eyeglass protection and mounting system mounted upon a pair of eyeglasses during a ‘stowed’ condition, according to an embodiment of the disclosure.

FIG. 2 is a perspective view of the eyeglass protection and mounting system of FIG. 1, according to an embodiment of the present disclosure.

FIG. 3 is a perspective view of the eyeglass protection and mounting system of FIG. 1 with a mask mounting system, according to an embodiment of the present disclosure.

FIG. 4 is a perspective view of an embodiment of the eyeglass protection and mounting system of FIG. 1 having securing mechanisms for the retainers, according to an embodiment of the present disclosure.

FIG. 5 is a perspective view of the eyeglass protection and mounting system of FIG. 1 during an ‘in-use’ condition, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an eyeglass accessory and more particularly to an eyeglass protection and mounting system as used to improve the protection of a pair of eyeglasses.

Generally, the eyeglass protection and mounting system may provide an efficient and novel way to protect eyeglasses with a system which remains with the eyeglasses even when not in use. In one embodiment of the present invention, the eyeglass protection and mounting systems may comprise an elastic sleeve having two open ends and a cavity therebetween through which portions of the eyeglasses may pass. Further, the system may include a pair of retainers around the sleeve, one proximate to each end, to retain the sleeve to the eyeglasses; and also a mounting system for suspending items from the eyeglasses. The eyeglass protection and mounting system may be applicable to any type of wearable eyeglasses having two lens, including sunglasses, prescription eyewear, heads-up display (HUD) glasses, glasses having screens to view transmitted footage from an electronic device, or any other type of two-lens eyewear.

The eyeglass protection system may include a sleeve which, in an in-use condition, may cover and protect the lens of an eyeglass. In a stowed condition, the system may be slid back upon and retained to the template of the eyeglasses. Two sleeve assemblies may be used for a single pair of eyeglasses; one corresponding to each lens. Retainers may be used to constrict the sleeve at either end around the temple to retain it to the eyeglasses, especially if the elastic material used for the sleeve itself is insufficient to retain the sleeve to the temple. Indicia and any variety of ornamental designs may be printed or otherwise incorporated upon the exterior of each sleeve, and may be printed to be most readable in either a stowed or in-use condition. In an in-use condition, the sleeve may be stretched over the entirety of each lens of the eyeglasses. The elastic sleeve may shrink when not stretched around either the temple or lenses of the eyeglasses.

Additionally, a mounting system for facemasks and other accessories may be integrated to the sleeve. This mounting system may comprise one or more of the following: a button, two loops of cord, a rigid hanger or hook, and a stitch or gap through which a hook may be passed. Furthermore, different colors, ornamental designs, and rhinestone adornments may be integrated.

Retainers may be used to constrict the sleeve anywhere on or off the sleeve. For example, the retainers may constrict the sleeve on the around the arm of the glasses, or around the middle of the sleeve to retain them to any part of the glasses. These retainers may be placed upon any part of the sleeve in varying embodiments, especially if the elastic material of the sleeve is insufficient to retain them to the arm or other part of the eyeglasses.

Buttons or snaps or other items may be used to secure the two pieces of material that meet in the middle of the nose piece or at the end of the material on the arm of the glasses if needed for a secure fit on the glasses.

In one alternative embodiment, a lengthened sleeve may be provided which is long enough to cover both lenses. In this way, only a single sleeve assembly is needed for use with a single pair of eyeglasses. Optionally, multiple stretchy materials can be used together to construct a single sleeve.

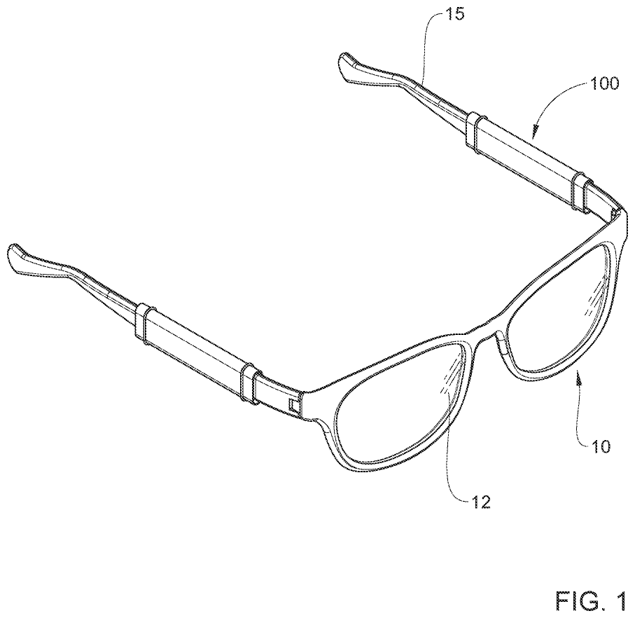

Referring now more specifically to the drawings by numerals of reference, there is shown in FIGS. 1-5, various views of an eyeglass protection and mounting system 100.

FIG. 1 shows an eyeglass protection and mounting system 100 during a stowed condition, according to an embodiment of the present disclosure. Here, the eyeglass protection and mounting system 100 may be beneficial for use by a user to protect the lens of an eyeglass from scratches, dust, radiation damage, and debris. As illustrated, the eyeglass protection and mounting system 100 may be able to be stowed on the temple 15 of an eyeglass 10, with one eyeglass protection and mounting system 100 mounted on a left temple, and another eyeglass protection and mounting system 100 mounted on a right temple. In this condition, eyeglasses 10 may be worn and used normally, and eyeglass protection and mounting system 100 may even provide protection to temple 15 and serve as a desirable fashion accessory when in use. When eyeglasses 10 are not being actively used and worn, each eyeglass protection and mounting system 100 may be slid up from the temple 15 to the lens 12, expanding significantly to stretch over and cover each lens 12 of eyeglass 10. In both conditions (stowed on the temple, or covering the lens), the elasticity of eyeglass protection and mounting system 100 over the structure of eyeglass 10 may create enough friction to retain eyeglass protection and mounting system 100 to eyeglass 10, using particular tension mechanisms in addition to the elasticity of the fabric itself.

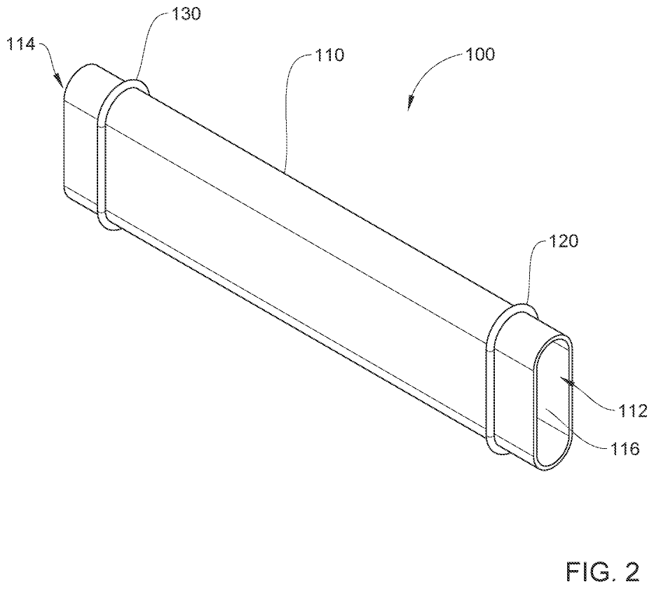

FIG. 2 shows the eyeglass protection and mounting system 100 of FIG. 1, according to an embodiment of the present disclosure. The eyeglass protection and mounting system 100 may include sleeve 110 with first-retainer 120 and second-retainer 130. Sleeve 110 may be characterized by first open end 112 and second open end 114 and cavity 116 therebetween, thereby forming a flexible cylindrical tube. Sleeve 110 may be constructed of an elastic fabric. Spandex is seen as an ideal material; however, any fabric material able to expand at least four times its surface area may be considered a candidate. First-retainer 120 and second-retainer 130 are each disposed proximally to each of the two open ends 112 and 114 respectively. Each of first-retainer 120 and second-retainer 130 may be an elastic band. Each of first-retainer 120 and second-retainer 130 may circumscribe sleeve 110 exteriorly and apply tension upon sleeve 110 to constrict cavity 116. These retainers must be able to shrink to a size smaller than a temple 15 (FIG. 1) of an eyeglass 10 (FIG. 1), such that when sleeve 110 is slid down along temple 15 (FIG. 1), the retainers restrict sleeve 110 against temple 15 (FIG. 1) and the resulting friction prevents sleeve 110 from sliding off temple 15 (FIG. 1) without deliberate manipulation. When slightly expanded, sleeve 110 must be sufficiently large to accept the temple 15 (FIG. 1) of eyeglass 10 (FIG. 1), and when fully expanded, sleeve 110 must be sufficiently elastic to pass over lens 12 (FIG. 1) of eyeglass 10 (FIG. 1).

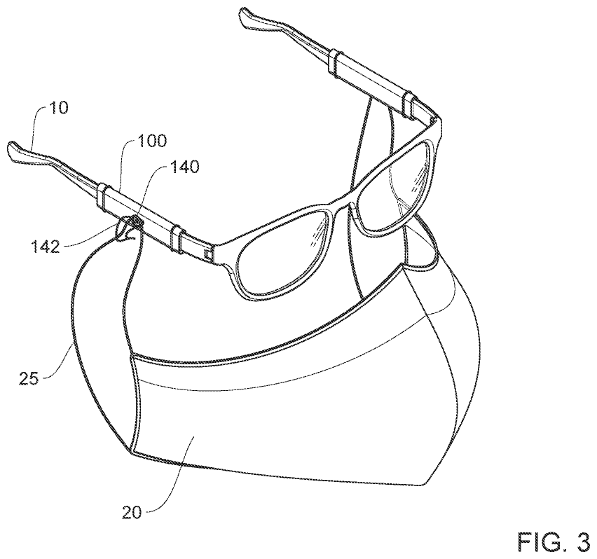

FIG. 3 is a perspective view of an embodiment of the eyeglass protection and mounting system 100 of FIG. 1 with a mask mounting system, according to an embodiment of the present disclosure. The eyeglass protection and mounting system 100 may further include button 140. Button 140 may be sewn exteriorly to sleeve 110. The eyeglass protection and mounting system 100 may further include bight of cord 142. Bight of cord 142 may also sewn exteriorly to sleeve 110 at either end, and proximally to button 140, such that it may be selectively looped about button 140 to form a fastenable retainer. The resulting loop of cord may have sufficient length to loop around the button and leave a small hanger formed by the cord. A facemask 20 may be hung by earloops 25 from this retainer on either side. Accordingly, the eyeglass protection and mounting system 100 may also serve as a convenient retention mechanism to adapt eyeglass temples into hangers for wearing or stowing a facemask 20, especially when a user's ears may become irritated b the facemask ear-loops 25. Preferably, bight of cord 142 should be disposed below button 140 when it is worn on temple 15 (FIG. 1) of eyeglass 10, such that the pull of gravity on facemask 20 helps retain bight of cord 142 to button 140, and does not pull it off.

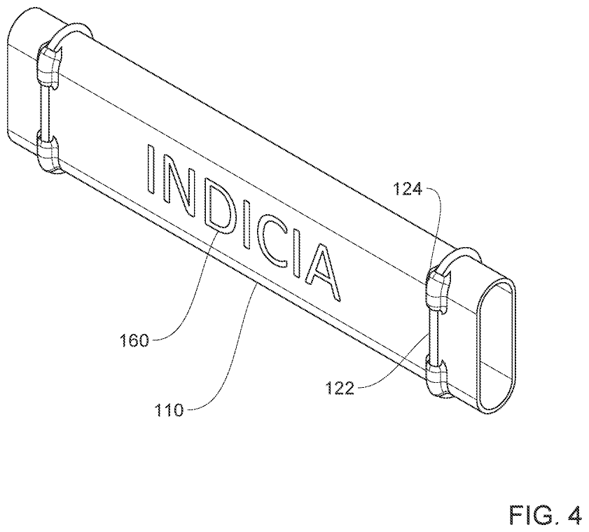

FIG. 4 is a perspective view of an embodiment of the eyeglass protection and mounting system 100 of FIG. 1 having securing mechanisms for the retainers, according to an embodiment of the present disclosure. In the illustrated embodiment, each of first-retainer 120 (FIG. 2) and second-retainer 130 (FIG. 2) are O-rings. As shown, sleeve 110 further comprises a plurality of passages 124. Each of first-retainer 120 and second-retainer 130 are passed through one or more of the plurality of passages 124, such that each of first-retainer 120 and second-retainer 130 are retained to sleeve 110. In the illustrated embodiment, each of the plurality of passages 124 is formed by a piece of fabric sewn to sleeve 110 on either side of the piece of fabric, with two openings on either end of the piece of fabric to enable either first-retainer 120 or second-retainer 130 to be passed between the piece of fabric and sleeve 110. This may be a permanent retention, with the piece of fabric being sewn over the top of O-ring 122. In an alternate embodiment, each of the plurality of passages 124 may be formed by a slit cut into sleeve 110, such that either first-retainer 120 or second-retainer 130 is passed through the slit.

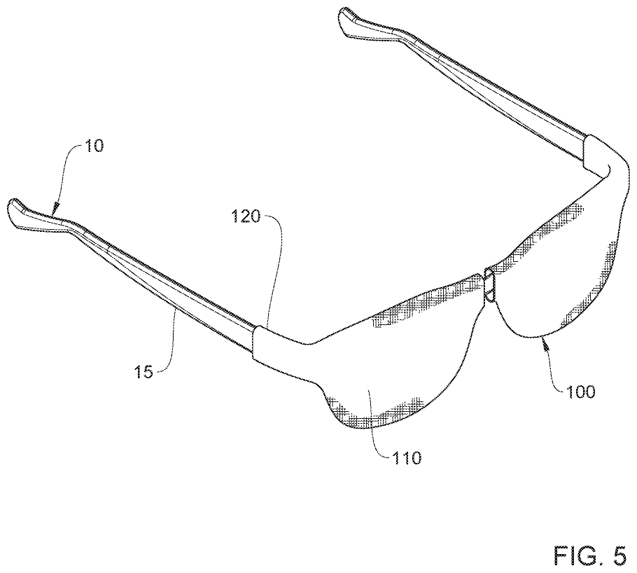

FIG. 5 is a perspective view of the eyeglass protection and mounting system 100 of FIG. 1 in an in-use condition, according to an embodiment of the present disclosure. In one exemplary embodiment, sleeve 110 is constructed of spandex (Polyether-polyurea copolymer). As shown, sleeve 110 must be sufficiently elastic to stretch over and protect lens 12 (FIG. 1) of eyeglass 10. When sleeve 110 is over lens 12 (FIG. 1), temple 15 is left exposed. First-retainer 120 and second-retainer 130 (FIG. 2) constrict down at either end of lens 12 (FIG. 1), securely retaining sleeve 110 over lens 12 (FIG. 1) as shown.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. An eyeglass protection and mounting system comprising:
a sleeve having two open ends and a cavity therebetween, the sleeve being constructed of an elastic fabric; and
a first-retainer and a second-retainer disposed proximally to each of the two open ends respectively, each of the first-retainer and the second-retainer being an elastic band, each of the first-retainer and the second-retainer circumscribing the sleeve exteriorly and applying tension upon the sleeve to constrict the cavity;
wherein the sleeve is sufficiently large to accept a temple of an eyeglass and is sufficiently elastic to pass over a lens of the eyeglass.

2. The eyeglass protection and mounting system of claim 1, further comprising:
a button sewn exteriorly to the sleeve.

3. The eyeglass protection and mounting system of claim 2, further comprising:
a bight of cord sewn exteriorly to the sleeve at either end, the loop of cord having sufficient length to loop around the button.

4. The eyeglass protection and mounting system of claim 1, wherein
each of the first-retainer and the second-retainer are O-rings.

5. The eyeglass protection and mounting system of claim 1, whereby the sleeve is constructed of spandex (Polyether-polyurea copolymer).

6. The eyeglass protection and mounting system of claim 1, wherein the sleeve further comprises a plurality of passages, and
each of the first-retainer and the second-retainer are passed through one or more of the plurality of passages, such that each of the first-retainer and the second-retainer are retained to the sleeve.

7. The eyeglass protection and mounting system of claim 1, wherein each of the plurality of passages is formed by a piece of fabric sewn to the sleeve on either side of the piece of fabric, with two openings on either end of the piece of fabric to enable either the first-retainer or the second-retainer to be passed between the piece of fabric and the sleeve.

8. The eyeglass protection and mounting system of claim 1, wherein each of the plurality of passages is formed by a slit cut into the sleeve, such that either the first-retainer or the second-retainer is passed through the slit.

9. An eyeglass protection and mounting system comprising:
a sleeve having two open ends and a cavity therebetween, the sleeve being constructed of an elastic fabric;
a first-retainer and a second-retainer disposed proximally to each of the two open ends respectively, each of the first-retainer and the second-retainer being an elastic band, each of the first-retainer and the second-retainer circumscribing the sleeve exteriorly and applying tension upon the sleeve to constrict the cavity;
a button sewn exteriorly to the sleeve; and
a bight of cord sewn exteriorly to the sleeve at either end, the loop of cord having sufficient length to loop around the button;
wherein the sleeve is sufficiently large to accept a temple of an eyeglass and is sufficiently elastic to pass over a lens of the eyeglass;
wherein each of the first-retainer and the second-retainer are O-rings; and
whereby the sleeve is constructed of spandex (Polyether-polyurea copolymer).
